(19) United States
(12) Patent Application Publication
(10) Pub. No.: US 2007/0054136 A1
(43) Pub. Date: Mar. 8, 2007

(54) Film forming composition, insulating film and production process of the insulating film

(75) Inventors: Kazutaka Takahashi, Shizuoka (JP); Koji Wariishi, Shizuoka (JP); Kensuke Morita, Shizuoka (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/515,818

(22) Filed: Sep. 6, 2006

(30) Foreign Application Priority Data
Sep. 7, 2005 (JP) P.2005-259396

(51) Int. Cl. B32B 9/04; C07F 7/18

(52) U.S. Cl. 428/447; 528/35; 528/37; 556/464

(57) ABSTRACT

A film forming composition comprising: at least one of a compound represented by formula (I) as defined in the specification, a hydrolysate of the compound represented by formula (I) and a polycondensate of the compound represented by formula (I); and a silicon surfactant, a production process of an insulating film by using the composition and the insulating film.

### BACKGROUND OF THE INVENTION

1. Field of the Invention

The present invention relates to a film forming composition. More specifically, the invention pertains to a composition capable of forming, as an interlayer insulating film material in semiconductor devices, a film having a uniform thickness and moreover, capable of forming an insulating film excellent in dielectric constant properties and film strength; a forming method of the insulating film; and the insulating film.

2. Description of the Related Art

Silica (SiO₂) films formed in a vacuum process such as chemical vapor deposition (CVD) have been used popularly as interlayer insulating films in semiconductor devices or the like. In recent years, application type insulating films having, as an essential component thereof, a hydrolysis product of a tetraalkoxysilane and called “SOG (Spin on Glass) film” have been used in order to form more uniform interlayer insulating films. As the integration degree of semiconductor devices or the like becomes higher, interlayer insulating films referred to as organic SOG which are composed mainly of polyorganosiloxane and have a low dielectric constant have been increasingly developed.

CVD-SiO₂ films exhibiting the lowest dielectric constant of all the films made of an inorganic material have even a dielectric constant of about 4. SiOF films which have recently been investigated as low-dielectric-constant CVD films have a dielectric constant of from about 3.3 to 3.5. SiOF films however have high hygroscopic property and their dielectric constant increases while they are used.

Under such situations, a process of adding a high boiling point solvent or thermally decomposable compound to organopolysiloxane, which is an insulating film material excellent in insulating property, heat resistance and durability, to form pores, thereby reducing a dielectric constant is known. Formation of pores contributes to a reduction in dielectric constant properties of the film, but it lowers mechanical property and after moisture absorption, the dielectric constant increases. In addition to these problems, copper used for interconnects diffuses in the insulating film owing to the formation of mutually connected pores.

An insulating film (refer to JP-A-1-313528) prepared using a compound having silicon atoms connected each other via a linear alkyl group is required to have more improved dielectric constant and film strength. An insulating film (refer to Science, 302, 266(2003)) using a cyclic compound has not enough CMP (chemical mechanical polishing) resistance.

### SUMMARY OF THE INVENTION

The present invention relates to a composition for overcoming the above-described problems, a production process of an insulating film by using the composition, and an insulating film prepared using the process. More specifically, an object of the present invention is to provide a composition capable of forming a silicone film suited for the use as an interlayer insulating film in semiconductor devices or the like and having a uniform thickness and moreover capable of forming a film excellent in dielectric constant properties, film strength and CMP resistance; an insulating film formed using the composition; and a production process of the insulating film. (An “insulating film” is also referred to as a “dielectric film” or a “dielectric insulating film”, and these terms are not substantially distinguished.)

It has been found that the above-described object can be attained by the below-described constitutions.

(1) A film forming composition comprising:

at least one of a compound represented by formula (I), a hydrolysate of the compound represented by formula (I) and a polycondensate of the compound represented by formula (I); and

a silicon surfactant:

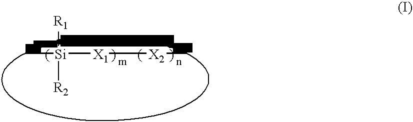

wherein R₁ and R₂ each independently represents a hydrogen atom or a substituent;

m represents an integer of 2 or more;

n represents an integer of 0 or more;

X₁ represents —O—, —S—, —Si(R₃) (R₄)— or —C(R₅) (R₆)—;

X₂ represents —Si(R₃) (R₄)— or —C(R₅) (R₆)—; and

R₃, R₄, R₅ and R₆ each independently represents a hydrogen atom or a substituent, and

wherein two of R₃ to R₆ present on two atoms adjacent to each other may be coupled to form a double bond between the two adjacent atoms, and

wherein when there exist a plurality of X₁'s, X₂'s, R₁'s, R₂'s, R₃'s, R₄'s, R₅'s and R₆'s, the plurality of X₁'s, X₂'s, R₁'s, R₂'s, R₃'s, R₄'s, R₅'s and R₆'s each may be the same or different, and

wherein at least two of R₁ to R₆ may be coupled to form a ring or form a multimer of the compound represented by formula (I), provided that the compound represented by formula (I) has at least two hydrolytic groups as R₁, R₂, R₃, R₄, R₅ or R₆.

(2) The film forming composition as described in (1) above, which comprises at least one of two or more compounds represented by formula (I), a hydrolysate of the two or more compounds represented by formula (I) and a polycondensate of the two or more compounds represented by formula (I).

(3) The film forming composition as described in (1) or (2) above, which comprises the silicon surfactant in an amount of from 0.01 to 1 mass % based on a total amount of the film forming composition.

(4) The film forming composition as described in (3) above, which comprises the silicon surfactant in an amount of from 0.1 to 0.5 mass % based on a total amount of the film forming composition.

(5) The film forming composition as described in any of (1) to (4) above,

wherein the silicon surfactant contains an alkylene oxide and a dimethylsiloxane.

(6) The film forming composition as described in any of (1) to (5) above, which further comprises an organosilicon compound represented by formula (A) or a polymer obtained by utilizing the organosilicon compound represented by formula (A):
(Rₐ)_{q}—Si—(ORb)_{4-q} (A)
wherein Rₐ represents an alkyl group, an aryl group or a heterocyclic group;

R_{b} represents a hydrogen atom, an alkyl group, an aryl group or a silyl group; and

q represents an integer of from 0 to 4, and when q or 4-q is 2 or more, Rₐ's or R_{b}'s may be the same or different.

(7) The film forming composition as described in (6) above,

wherein q is an integer of from 0 to 2, and R_{b} is an alkyl group.

(8) A production process of a film, which comprises:

applying a composition as described in any of (1) to (7) above onto a substrate; and

heating the applied composition.

(9) An insulating film formed from a composition as described in any of (1) to (7) above.

### DETAILED DESCRIPTION OF THE INVENTION

The film forming composition of the invention contains a compound represented by the formula (I) or hydrolysate and/or polycondensate of the compound, and a silicon surfactant.

The term “polycondensate” as used herein means a condensation product of a silanol group generated after the hydrolysis of the compound. In this condensation product, condensation of all the silanol groups is not required. The term “condensation product” embraces the product in which some of the silanol groups have been condensed and a mixture of condensation products which differ in the degree of condensation.

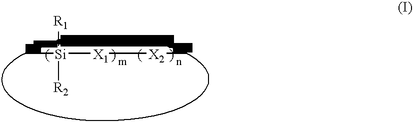

In the formula (I), R₁ and R₂ each independently represents a hydrogen atom or a substituent.

The letter m represents an integer of 2 or more, and the letter n represents an integer of 0 or more. X₁ represents —O—, —S—, —Si(R₃)(R₄)— or —C(R₅)(R₆)—. X₂ represents —Si(R₃)(R₄)— or —C(R₅)(R₆)—, in which R₃, R₄, R₅ and R₆ each independently represents a hydrogen atom or a substituent.

Two of R₃ to R₆ present on two atoms adjacent to each other may be coupled to form a double bond between the two adjacent atoms.

When there exist a plurality of X₁'s, X₂'s, R₁'s, R₂'s, R₃'s, R₄'s, R₅'s and R₆'s, they may be the same or different. At least two of R₁ to R₆ may be coupled to form a ring or form a multimer of the compound represented by formula (I).

The compound represented by the formula (I) however has at least two hydrolytic groups as R₁, R₂, R₃, R₄, R₅ or R_{6.}

Examples of the substituent represented by R₁ to R₆ include:

halogen atoms (fluorine, chlorine, bromine and iodine atoms),

linear, branched or cyclic alkyl groups (preferably, C₁₋₁₀ alkyl groups such as methyl, t-butyl, cyclopentyl and cyclohexyl),

alkenyl groups (preferably, C₂₋₁₀ alkenyl groups such as vinyl and propenyl),

alkynyl groups (preferably, C₂₋₁₀ alkynyl groups such as ethynyl and phenylethynyl),

aryl groups (preferably, C₆₋₂₀ aryl groups such as phenyl, 1-naphthyl and 2-naphthyl),

acyl groups (preferably, C₂₋₁₀ acyl groups such as benzoyl),

alkoxy groups (preferably, C₁₋₁₀ alkoxy groups such as methoxy, ethoxy, i-propoxy and t-butoxy),

silyloxy groups (preferably, C₃₋₁₀ silyloxy groups such as trimethylsilyloxy, triethylsilyloxy and t-butyldimethylsilyloxy),

aryloxy groups (preferably, C₆₋₂₀ aryloxy groups such as phenoxy),

acyloxy groups (preferably, C₂₋₁₀ acyloxy groups such as acetyloxy and ethylcarbonyloxy), and hydroxyl group.

Of these, chlorine atom, linear, branched or cyclic C₁₋₅ alkyl groups, C₂₋₅ alkenyl groups, C₂₋₅ alkynyl groups and C₁₋₅ alkoxy groups are more preferred.

These substituents may be substituted with another substituent.

The compound represented by the formula (I) has at least two hydrolytic groups as R₁ to R₆. For example, each of R₁ and R₂ may be a hydrolytic group, or when the compound has two R₁'s, these two R₁'s may be hydrolytic groups.

Examples of the hydrolytic group as R₁ to R₆ include halogen atoms, alkoxy groups, aryloxy groups, acyloxy groups and silyloxy group. Substituted or unsubstituted alkoxy groups (such as methoxy, ethoxy, propoxy, butoxy and methoxyethoxy) are preferred as R₁ to R₆, of which unsubstituted C₁₋₅ alkoxy groups are most preferred.

The compound represented by the formula (I) has preferably three or more hydrolytic groups and the upper limit of the number of the hydrolytic groups is 20.

It is preferred that hydrolytic groups are present at two or more substitution sites of R₁ to R₆

With regard to the substituents represented by R₁ to R₆, substituents which are the same or different may be coupled together to form a multimer or a ring. The ring thus formed is preferably a 5- to 8-membered ring, more preferably a 5- to 6-membered ring.

The letter m represents an integer of 2 or more, preferably from 2 to 4.

The letter n represents an integer of 0 or more, preferably from 0 to 1.

Specific examples of the formula (I) will next be described, but the present invention is not limited by them.

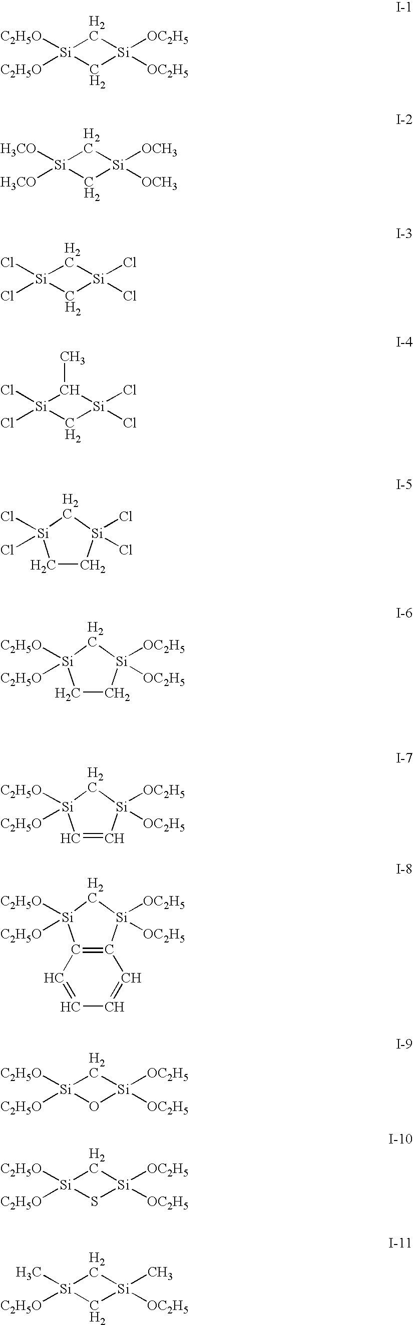

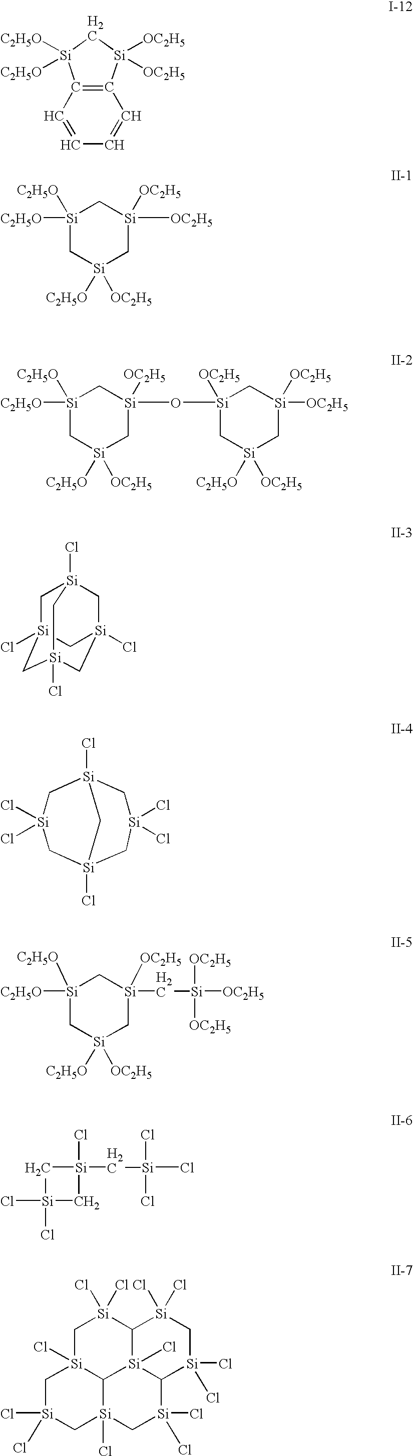

The compound represented by the formula (I) has a molecular weight of usually from 200 to 1000, preferably from 250 to 900.

The compound represented by the formula (I) can be prepared easily by the technique known widely in the chemistry of silicon. It can be synthesized, for example, by the process as described in Tetrahedron Letters, 34(13), 2111(1993).

The film forming composition of the invention can be prepared either by using the compound represented by the formula singly or by using two or more of the compounds in combination.

Known silicon compounds (such as tetramethoxysilane, tetraethoxysilane, methyltrimethoxysilane and methyltriethoxysilane) which are ordinarily added to film forming compositions may be used in combination with the compound represented by the formula (I).

Another silane compound which may be added as needed in order to improve the film properties of the material is, for example, an organosilicon compound represented by the below-described formula (A) or a polymer obtained by using it as a monomer. Here, the meaning of the polymer includes a hydrolysate and/or a partial condensate of the organosilicon compound represented by the following formula (A).
(Rₐ)_{q}—Si—(ORb)_{4-q} (A)

In the formula (A), Rₐ represents an alkyl, aryl or heterocyclic group and R_{b} represents a hydrogen atom, an alkyl group, an aryl group or a silyl group. These groups may have a substituent further.

The letter q represents an integer of from 0 to 4. When q or 4-q is 2 or more, Rₐ'S or R_{b}'s may be the same or different. The compounds may be coupled each other via the substituent of Rₐ or R_{b} to form a multimer.

The letter q is preferably from 0 to 2, while R_{b} is preferably an alkyl group. Preferred examples of the compound when q represents 0 include tetramethoxysilane (TMOS) and tetraethoxysilane (TEOS), while those of the compound when q represents 1 or 2 include the following compounds.

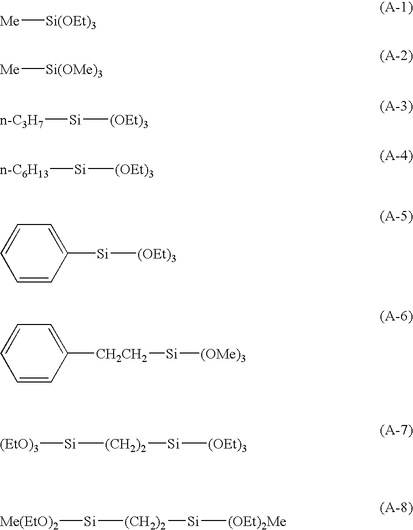

When another silane compound such as the compound of the formula (A) is used in combination, it is added preferably in a range of from 1 to 200 mole %, more preferably in a range of from 10 to 100 mole % relative to the compound of the formula (I).

By using the compound of the formula (I), if necessary, in combination with another silane compound, a hydrolysate and/or condensate is obtained by the so-called sol-gel reaction.

It is also possible to add another silicon-containing compound to the compound of the formula (I) and simultaneously carry out hydrolysis and/or condensation. Specific examples of the silicon-containing compound other than the compound of the formula (I) include dimethyldiethoxysilane, methyltrimethoxysilane, methyltriethoxysilane, phenyltrimethoxysilane and tetraethoxysilane.

When hydrolysis and/or condensation of the silane compound of the formula (I) is performed, it is preferred to add from 0.5 to 150 moles of water, especially preferably from 1 to 100 moles of water per mole of the compound (I). When the amount of water is less than 0.5 mole, the resulting film is sometimes inferior in crack resistance. When it exceeds 150 moles, on the other hand, precipitation or gelation of the polymer during hydrolysis and/or condensation sometimes occurs.

When the composition of the invention is prepared, it is preferred to use a basic catalyst or an acid catalyst, and a metal chelate compound at the time of hydrolysis and/or condensation of the silane compound.

(Basic Catalysts)

Examples of the basic catalyst include sodium hydroxide, potassium hydroxide, lithium hydroxide, pyridine, pyrrole, piperazine, pyrrolidine, piperidine, picoline, monoethanolamine, diethanolamine, dimethylmonoethanolamine, monomethyldiethanolamine, triethanolamine, diazabicyclooctane, diazabicyclononane, diazabicycloundecene, tetramethylammonium hydroxide, tetraethylammonium hydroxide, tetrapropylammonium hydroxide, tetrabutylammonium hydroxide, ammonia, methylamine, ethylamine, propylamine, butylamine, pentylamine, hexylamine, octylamine, nonylamine, decylamine, N,N-dimethylamine, N,N-diethylamine, N,N-dipropylamine, N,N-dibutylamine, trimethylamine, triethylamine, tripropylamine, tributylamine, cyclohexylamine, trimethylimidine, 1-amino-3-methylbutane, dimethylglycine, and 3-amino-3-methylamine. Of these, the amines and amine salts are preferred, of which the organic amines and organic amine salts are especially preferred and the alkylamines and tetraalkylammonium hydroxides are most preferred. These basic catalysts may be used either singly or in combination.

(Acid Catalyst)

Examples of the acid catalyst include inorganic acids such as hydrochloric acid, nitric acid, sulfuric acid, hydrofluoric acid, phosphoric acid, boric acid and oxalic acid; and organic acids such as acetic acid, propionic acid, butanoic acid, pentanoic acid, hexanoic acid, heptanoic acid, octanoic acid, nonanoic acid, decanoic acid, oxalic acid, maleic acid, methylmalonic acid, adipic acid, sebacic acid, gallic acid, butyric acid, mellitic acid, arachidonic acid, shikimic acid, 2-ethylhexanoic acid, oleic acid, stearic acid, linoleic acid, linolenic acid, salicylic acid, benzoic acid, p-aminobenzoic acid, p-toluenesulfonic acid, benzenesulfonic acid, monochloroacetic acid, dichloroacetic acid, trichloroacetic acid, trifluoroacetic acid, formic acid, malonic acid, sulfonic acid, phthalic acid, fumaric acid, citric acid, tartaric acid, succinic acid, itaconic acid, mesaconic acid, citraconic acid, malic acid, a hydrolysate of glutaric acid, a hydrolysate of maleic anhydride, and a hydrolysate of phthalic anhydride. Of these, the organic carboxylic acids are more preferred. These acid catalysts may be used either singly or in combination.

(Metal Chelate)

Examples of the metal chelate compound include titanium chelate compounds such as triethoxy.mono(acetylacetonato)titanium, tri-n-propoxy.mono(acetylacetonato)titanium, tri-i-propoxy.mono(acetylacetonato)titanium, tri-n-butoxy.mono(acetylacetonato)titanium, tri-sec-butoxy.mono(acetylacetonato)titanium, tri-t-butoxy.mono(acetylacetonato)titanium, diethoxy.bis(acetylacetonato)titanium, di-n-propoxy.bis(acetylacetonato)titanium, di-i-propoxy.bis(acetylacetonato)titanium, di-n-butoxy.bis(acetylacetonato)titanium, di-sec-butoxy.bis(acetylacetonato)titanium, di-t-butoxy.bis(acetylacetonato)titanium, monoethoxy.tris(acetylacetonato)titanium, mono-n-propoxy.tris(acetylacetonato)titanium, mono-i-propoxy.tris(acetylacetonato)titanium, mono-n-butoxy.tris(acetylacetonato)titanium, mono-sec-butoxy.tris(acetylacetonato)titanium, mono-t-butoxy-tris(acetylacetonato)titanium, tetrakis(acetylacetonato)titanium, triethoxy.mono(ethylacetoacetaato)titanium, tri-n-propoxy.mono(ethylacetoacetato)titanium, tri-i-propoxy.mono(ethylacetoacetato) titanium, tri-n-butoxy.mono(ethylacetoacetato)titanium, tri-sec-butoxy.mono(ethylacetoacetato) titanium, tri-t-butoxy-mono(ethylacetoacetato)titanium, diethoxy.bis(ethylacetoacetato)titanium, di-n-propoxy.bis(ethylacetoacetato)titanium, di-i-propoxy.bis(ethylacetoacetato)titanium, di-n-butoxy.bis(ethylacetoacetato)titanium, di-sec-butoxy.bis(ethylacetoacetato)titanium, di-t-butoxy.bis(ethylacetoacetato)titanium, monoethoxy.tris(ethylacetoacetato)titanium, mono-n-propoxy.tris(ethylacetoaetato)titanium, mono-i-propoxy.tris(ethylacetoacetato)titanium, mono-n-butoxy.tris(ethylacetoacetato)titanium, mono-sec-butoxy.tris(ethylacetoacetato)titanium, mono-t-butoxy.tris(ethylacetoacetato)titanium, tetrakis(ethylacetoacetato)titanium, mono(acetylacetonato)tris(ethylacetoacetato)titanium, bis(acetylacetonato)bis(ethylacetoacetato)titanium, and tris(acetylacetonato)mono(ethylacetoacetato)titanium; zirconium chelate compounds such as triethoxy.mono(acetylacetonato)zirconium, tri-n-propoxy.mono(acetylacetonato)zirconium, tri-i-propoxy.mono(acetylacetonato)zirconium, tri-n-butoxy.mono(acetylacetonato)zirconium, tri-sec-butoxy.mono(acetylacetonato)zirconium, tri-t-butoxy.mono(acetylacetonato)zirconium, diethoxy.bis(acetylacetonato)zirconium, di-n-propoxy.bis(acetylacetonato)zirconium, di-i-propoxy.bis(acetylacetonato)zirconium, di-n-butoxy.bis(acetylacetonato)zirconium, di-sec-butoxy.bis(acetylacetonato)zirconium, di-t-butoxy.bis(acetylacetonato)zirconium, monoethoxy.tris(acetylacetonato)zirconium, mono-n-propoxy.tris(acetylacetonato)zirconium, mono-i-propoxy.tris(acetylacetonato)zirconium, mono-n-butoxy.tris(acetylacetonato)zirconium, mono-sec-butoxy.tris(acetylacetonato)zirconium, mono-t-butoxy.tris(acetylacetonato)zirconium, tetrakis(acetylacetonato)zirconium, triethoxy.mono(ethylacetoacetato)zirconium, tri-n-propoxy.mono(ethylacetoacetato)zirconium, tri-i-propoxy.mono(ethylacetoacetato)zirconium, tri-n-butoxy.mono(ethylacetoacetato)zirconium, tri-sec-butoxy.mono(ethylacetoacetato)zirconium, tri-t-butoxy.mono(ethylacetoacetato)zirconium, diethoxy.bis(ethylacetoacetato)zirconium, di-n-propoxy.bis(ethylacetoacetato)zirconium, di-i-propoxy.bis(ethylacetoacetato)zirconium, di-n-butoxy.bis(ethylacetoacetato)zirconium, di-sec-butoxy.bis(ethylacetoacetato)zirconium, di-t-butoxy.bis(ethylacetoacetato)zirconium, monoethoxy.tris(ethylacetoacetato)zirconium, mono-n-propoxy.tris(ethylacetoacetato)zirconium, mono-i-propoxy.tris(ethylacetoacetato)zirconium, mono-n-butoxy.tris(ethylacetoacetato)zirconium, mono-sec-butoxy.tris(ethylacetoacetato)zirconium, mono-t-butoxy.tris(ethylacetoacetato)zirconium, tetrakis(ethylacetoacetato)zirconium, mono(acetylacetonato)tris(ethylacetoacetato)zirconium, bis(acetylacetonato)bis(ethylacetoacetato)zirconium, and tris(acetylacetonato)mono(ethylacetoacetato)zirconium; and aluminum chelate compounds such as tris(acetylacetonato)aluminum and tris(ethylacetoacetato)aluminum. Of these, preferred are the chelate compounds of titanium or aluminum, of which the chelate compounds of titanium are especially preferred. These metal chelate compounds may be used either singly or in combination.

The total amount of the catalyst and chelate compound is usually from 0.00001 to 10 moles, preferably from 0.00005 to 5 moles, per mole of the silane compound such as compound represented by the formula (I) or (II). When the amount of the catalyst falls within the above-described range, there is little possibility of precipitation or gelation of the polymer occurring during reaction. In the invention, when the silane compound is hydrolyzed and/or condensed, the temperature is usually from 0 to 100° C., preferably from 10 to 90° C. and the time is usually from 5 minutes to 40 hours, preferably from 10 minutes to 20 hours.

(Silicon Surfactant)

The term “silicon surfactant” as used herein means a surfactant containing at least one Si atom. Although any silicon surfactant may be used in the invention, it preferably has a structure containing an alkylene oxide and dimethylsiloxane, more preferably a structure containing the following formula.

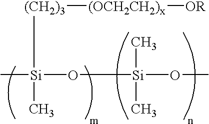

In the formula, R represents a hydrogen atom or a C₁₋₅ alkyl group, x represents an integer of from 1 to 20, m and n each independently represents an integer of from 2 to 100, with the proviso that a plurality of x's or R's may be the same or different.

Examples the silicon surfactant to be used in the invention include “BYK306” and “BYK307” (trade name; product of BYK Chemie), “SH7PA”, “SH21PA”, “SH28PA”, and “SH30PA” (each, trade name; product of Dow Corning Toray Silicone), and “Troysol S366” (trade name; product of Troy Corporation).

In the invention, these silicon surfactants may be used either singly or in combination. The silicon surfactant may be used in combination with a surfactant other than the silicon surfactant. Examples of such a surfactant to be used in combination include nonionic surfactants other than silicon surfactants, anionic surfactants, cationic surfactants, amphoteric surfactants, polyalkylene oxide surfactants and fluorosurfactants.

The amount of the silicon surfactant to be used in the invention is preferably from 0.01 mass % or more but not greater than 1 mass %, more preferably from 0.1 mass % or more but not greater than 0.5 mass % based on the total amount of the film forming coating solution. (In this specification, mass ratio is equal to weight ratio.)

(Coating Solution)

The film forming composition of the invention may be dissolved in a solvent to prepare a desirable coating solution prior to the application of the solution to a substrate. Preferred examples of the solvent usable for the preparation of the coating solution include ethylene dichloride, cyclohexanone, cyclopentanone, 2-heptanone, methyl isobutyl ketone, γ-butyrolactone, methyl ethyl ketone, methanol, ethanol, dimethylimidazolidinone, ethylene glycol monomethyl ether, ethylene glycol monoethyl ether, ethylene glycol dimethyl ether, 2-methoxyethyl acetate, ethylene glycol monoethyl ether acetate, propylene glycol monomethyl ether (PGME), propylene glycol monomethyl ether acetate (PGMEA), tetraethylene glycol dimethyl ether, triethylene glycol monobutyl ether, triethylene glycol monomethyl ether, isopropanol, ethylene carbonate, ethyl acetate, butyl acetate, methyl lactate, ethyl lactate, methyl methoxypropionate, ethyl ethoxypropionate, methylpyruvate, ethyl pyruvate, propyl pyruvate, N,N-dimethylformamide, dimethylacetamide, dimethyl sulfoxide, N-methylpyrrolidone, tetrahydrofuran, diisopropylbenzene, toluene, xylene, and mesitylene. These solvents may be used either singly or in combination.

Of these, preferred solvents include propylene glycol monomethyl ether acetate, propylene glycol monomethyl ether, 2-heptanone, cyclohexanone, γ-butyrolactone, ethylene glycol monomethyl ether, ethylene glycol monoethyl ether, ethylene glycol monoethyl ether acetate, propylene glycol monomethyl ether, propylene glycol monoethyl ether, ethylene carbonate, butyl acetate, methyl lactate, ethyl lactate, methyl methoxypropionate, ethyl ethoxypropionate, N-methylpyrrolidone, N,N-dimethylformamide, tetrahydrofuran, methyl isobutyl ketone, xylene, mesitylene, and diisopropylbenzene.

The total solid concentration of the film forming composition of the invention as a coating solution is preferably from 2 to 30 mass % and it is adjusted as needed, depending on the using purpose. When the total solid concentration of the composition is from 2 to 30 mass %, the film thus formed has a thickness within an appropriate range and in addition, the coating solution has better storage stability.

The film forming composition of the invention is applied to a substrate material such as silicon wafer, SiO₂ wafer or SiN wafer by using a coating technique such as spin coating, dipping, roll coating or spraying.

In this application, a film having a thickness on a dry basis of from about 0.05 to 1.5 μm or from about 0.1 to 3 μm can be formed in the case of single coating or double coating, respectively. The resulting film is then dried at normal temperature or heated using a hot plate, oven or furnace, whereby a vitreous insulating film or a macromolecular insulating film or an insulating film containing both as a mixture can be formed.

The heating atmosphere can be selected from nitrogen atmosphere, argon atmosphere or vacuum. The baking is performed preferably under conditions of the maximum baking temperature of from 300° C. or more but not greater than 430° C. Baking time is usually from 1 minute to 20 hours, preferably from 15 minutes to 10 hours.

More specifically, the film forming composition of the invention is applied to a substrate (usually, a substrate having a metal interconnect), for example, by spin coating, followed by preliminary heat treatment to remove the solvent by drying and simultaneously crosslink, to some extent, the siloxane contained in the film forming composition. Final heat treatment (annealing) is then conducted at a temperature of from 300° C. or more but not greater than 430° C., whereby an insulating film having a low dielectric constant can be formed.

By the above-described method, an insulating film having a low dielectric constant, more specifically, an insulating film having a dielectric constant of 2.6 or less, preferably 2.4 or less can be obtained. The dielectric constant of the film can be reduced further by adding a thermally decomposable compound or the like to the composition of the invention to make the resulting film porous.

The interlayer insulation film thus obtained has excellent insulating properties and is excellent also in evenness of the coating film, dielectric constant properties, crack resistance, and surface hardness. The composition of the invention is hence useful in applications such as interlayer insulation films for semiconductor devices such as LSI, system LSI, DRAM, SDRAM, RDRAM, and D-RDRAM, protective films such as surface coat films for semiconductor elements, interlayer insulation films for multilayered wiring boards, protective films or insulation preventive films for liquid-crystal display devices.

### EXAMPLES

The present invention will hereinafter be described by Examples. In all designations of part or parts and % mean “part by mass” or “parts by mass” and “mass %”, respectively, unless otherwise specifically indicated.

[Dielectric Constant]

The dielectric constant of an insulating film was calculated from the capacitance value (measured at 25° C.) as measured at 1 MHz by using a mercury probe (product of Four Dimensions) and “HP 4285A LCR meter” (trade name; product of Yokogawa Hewlett Packard).

[Film Strength]

The Young's modulus (measured at 25° C.) of the film was measured using “Nano Indenter SA2” (trade name; product of MTS Systems).

[CMP Resistance]

A Cu blanket film was prepared using a film made of each film forming composition. The film was subjected to CMP under a pressing pressure of 3.0 KPa by using “SPP600S” (product of Okamoto Machine Tool Works) and “IC1400” (trade name; product of Rodel) and presence or absence of film peel was observed.

The structure of the silane compounds used in the below-described Examples and Comparative Examples will be shown below.

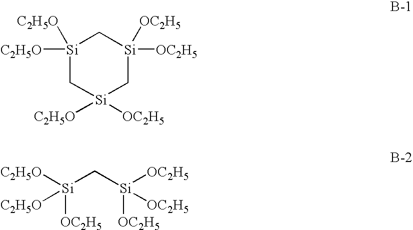

### Comparative Example 1

To a mixed solution of 12 mL of 0.1M hydrochloric acid, 110 g of propylene glycol monomethyl ether, 32 g of ethanol, 20 g of water and 8 g of cetyl trimethylammonium chloride was added 18 g of Compound B-1. The resulting mixture was reacted at 25° C. for 40 minutes. Under reduced pressure, the ethanol thus generated was distilled off, whereby Composition (I-1-1) was obtained.

The resulting Composition (I-1-1) was filtered through a 0.1-μm filter made of tetrafluoroethylene, followed by spin coating on an 8-inch silicon wafer. The film thus formed was heated at 110° C. for 60 seconds on a hot plate under a nitrogen stream, heated at 200° C. for 60 seconds, and then heated for 2 hours in an oven of 400° C. purged with nitrogen. The resulting insulating film having a thickness of 0.25 μm had a dielectric constant of 2.3, while the Young's modulus was 6.1 GPa. A Cu blanket film was formed using the resulting film and CMP was performed under a pressing pressure of 3.0 KPa by using “SPP600S” (product of Okamoto Machine Tool Works) and “IC1400” (trade name; product of Rodel), resulting in partial peeling at the edge portion of the film.

### Example 1

To a mixed solution of 12 mL of 0.1M hydrochloric acid, 110 g of propylene glycol monomethyl ether, 32 g of ethanol, 20 g of water and 8 g of cetyl trimethylammonium chloride was added 18 g of Compound B-1. The resulting mixture was reacted at 25° C. for 40 minutes. Under reduced pressure, the ethanol thus generated was distilled off, and 0.1 mass % of a silicon surfactant “BYK306” (trade name; product of BYK Chemie) was added to the residue, whereby Composition (I-1-2) was obtained.

The resulting Composition (I-1-2) was filtered through a 0.1 μm filter made of tetrafluoroethylene, followed by spin coating on an 8-inch silicon wafer. The film thus formed was heated at 110° C. for 60 seconds on a hot plate under a nitrogen stream, heated at 200° C. for 60 seconds, and then heated for 2 hours in an oven of 400° C. purged with nitrogen. The resulting insulating film having a thickness of 0.25 μm had a dielectric constant of 2.3, while the Young's modulus was 8.0 GPa. A Cu blanket film was formed using the resulting film and CMP was performed under a pressing pressure of 3.0 KPa by using “SPP600S” (product of Okamoto Machine Tool Works) and “IC1400” (trade name; product of Rodel). As a result, no film peel occurred.

### Example 2

To a mixed solution of 12 mL of 0.1M hydrochloric acid, 110 g of propylene glycol monomethyl ether, 32 g of ethanol, 20 g of water and 8 g of cetyl trimethylammonium chloride was added 18 g of Compound B-1. The resulting mixture was reacted at 25° C. for 40 minutes. Under reduced pressure, the ethanol thus generated was distilled off, and 0.1 mass % of a silicon surfactant “Troysol S366” (trade name; product of Troy Corporation) was added to the residue, whereby Composition (I-1-3) was obtained.

The resulting Composition (I-1-3) was filtered through a 0.1 μm filter made of tetrafluoroethylene, followed by spin coating on an 8-inch silicon wafer. The film thus formed was heated at 110° C. for 60 seconds on a hot plate under a nitrogen stream, heated at 200° C. for 60 seconds, and then heated for 2 hours in an oven of 400° C. purged with nitrogen. The resulting insulating film having a thickness of 0.25 μm had a dielectric constant of 2.3, while the Young's modulus was 8.2 GPa. A Cu blanket film was formed using the resulting film and CMP was performed under a pressing pressure of 3.0 KPa by using “SPP600S” (product of Okamoto Machine Tool Works) and “IC1400” (trade name; product of Rodel). As a result, no film peel occurred.

### Example 3

To a mixed solution of 12 mL of 0.1M hydrochloric acid, 110 g of propylene glycol monomethyl ether, 32 g of ethanol, 20 g of water and 8 g of cetyl trimethylammonium chloride was added 18 g of Compound B-1. The resulting mixture was reacted at 25° C. for 40 minutes. Under reduced pressure, the ethanol thus generated was distilled off, and 0.1 mass % of a silicon surfactant “SH28PA” (trade name; product of Dow Corning Toray Silicone) was added to the residue, whereby Composition (I-1-4) was obtained.

The resulting Composition (I-1-4) was filtered through a 0.1-μm filter made of tetrafluoroethylene, followed by spin coating on an 8-inch silicon wafer. The film thus formed was heated at 110° C. for 60 seconds on a hot plate under a nitrogen stream, heated at 200° C. for 60 seconds, and then heated for 2 hours in an oven of 400° C. purged with nitrogen. The resulting insulating film having a thickness of 0.25 μm had a dielectric constant of 2.3, while the Young's modulus was 7.9 GPa. A Cu blanket film was formed using the resulting film and CMP was performed under a pressing pressure of 3.0 KPa by using “SPP600S” (product of Okamoto Machine Tool Works) and “IC1400” (trade name; product of Rodel). As a result, no film peel occurred.

### Comparative Example 2

To a mixed solution of 12 mL of 0.1M hydrochloric acid, 110 g of propylene glycol monomethyl ether, 32 g of ethanol, 20 g of water and 8 g of cetyl trimethylammonium chloride was added 18 g of Compound B-1. The resulting mixture was reacted at 25° C. for 40 minutes. Under reduced pressure, the ethanol thus generated was distilled off and to the residue was added 0.1 mass % of sodium perfluorododecylsulfonate which was a fluorosurfactant, whereby Composition (I-1-5) was obtained.

The resulting Composition (I-1-5) was filtered through a 0.1-μm filter made of tetrafluoroethylene, followed by spin coating on an 8-inch silicon wafer. The film thus formed was heated at 110° C. for 60 seconds on a hot plate under a nitrogen stream, heated at 200° C. for 60 seconds, and then heated for 2 hours in an oven of 400° C. purged with nitrogen. The resulting insulating film having a thickness of 0.25 μm had a dielectric constant of 2.3, while it had a Young's modulus of 6.5 GPa. A Cu blanket film was formed using the resulting film and CMP was performed under a pressing pressure of 3.0 KPa by using “SPP600S” (product of Okamoto Machine Tool Works) and “IC1400” (trade name; product of Rodel). As a result, no film peel occurred.

### Comparative Example 3

To a mixed solution of 12 mL of 0.1M hydrochloric acid, 110 g of propylene glycol monomethyl ether, 32 g of ethanol, 20 g of water and 8 g of cetyl trimethylammonium chloride was added 15.5 g of Compound B-2. The resulting mixture was reacted at 25° C. for 40 minutes. Under reduced pressure, the ethanol thus generated was distilled off, and 0.1 mass % of a silicon surfactant “BYK306” (trade name; product of BYK Chemie) was added to the residue, whereby Composition (I-1-5) was obtained.

The resulting Composition (I-1-5) was filtered through a 0.1-μm filter made of tetrafluoroethylene, followed by spin coating on an 8-inch silicon wafer. The film thus formed was heated at 110° C. for 60 seconds on a hot plate under a nitrogen stream, heated at 200° C. for 60 seconds, and then heated for 2 hours in an oven of 400° C. purged with nitrogen. The resulting insulating film having a thickness of 0.25 μm had a dielectric constant of 2.6, while it had a Young's modulus of 7.1 GPa. A Cu blanket film was formed using the resulting film and CMP was performed under a pressing pressure of 3.0 KPa by using “SPP600S” (product of Okamoto Machine Tool Works) and “IC1400” (trade name; product of Rodel). As a result, no film peel occurred.

The results of Examples 1 to 3 and Comparative Examples 1 to 3 are shown in Table 1.

In the column of CMP resistance in Table 1, the composition free from the film peel was evaluated as A, while the composition which caused partial film peel at the edge portion was evaluated as B.

TABLE 1

| | | | Specific | Young's | |
|---|---|---|---|---|---|
| | Silane | | dielectric | modulus | CMP |
| | compound | Surfactant | constant | (Gpa) | resistance |
| Example 1 | B-1 | Silicon (BYK306) | 2.3 | 8.0 | A |
| Example 2 | B-1 | Silicon (S366) | 2.3 | 8.2 | A |
| Example 3 | B-1 | Silicon (SH28PA) | 2.3 | 7.9 | A |
| Comparative | B-1 | None | 2.3 | 6.1 | B |
| Example 1 | | | | | |
| Comparative | B-1 | Fluorosurfactant (sodium | 2.3 | 6.5 | B |
| Example 2 | | perfluorododecylsulfonate | | | |
| Comparative | B-2 | Silicon (BYK306) | 2.6 | 7.1 | A |
| Example 3 | | | | | |

It has been understood that the insulating film prepared using the film forming composition of the invention has a low dielectric constant, high strength and CMP resistance.

The present invention makes it possible to provide an insulating film suited for the use as an interlayer insulating film in semiconductor devices or the like, excellent in dielectric constant properties, and having high strength and CMP resistance.

By applying the composition of the invention containing a compound represented by the formula (I) or hydrolysate and/or polycondensate of the compound as a base polymer to a base material such as silicon wafer by dipping or spin coating, it is possible to completely fill the trenches between fine patterns. When the organic solvent is removed and crosslinking reaction is effected by heating, a vitreous film or a macromolecular film or mixture thereof can be formed. The film thus obtained constitutes a low-dielectric-constant and high strength insulator.

The term “low-dielectric-constant insulating film” as used herein means a film to be filled between interconnects in order to prevent interconnect delay which will otherwise occur owing to employment of multilayer interconnection to deal with high integration of ULSI. More specifically, it is a film having a dielectric constant of 2.6 or less.

The entire disclosure of each and every foreign patent application from which the benefit of foreign priority has been claimed in the present application is incorporated herein by reference, as if fully set forth.

What is claimed is:

1. A film forming composition comprising:
at least one of a compound represented by formula (I), a hydrolysate of the compound represented by formula (I) and a polycondensate of the compound represented by formula (I); and
a silicon surfactant: 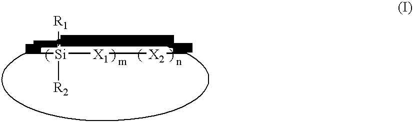
wherein R₁ and R₂ each independently represents a hydrogen atom or a substituent;
m represents an integer of 2 or more;
n represents an integer of 0 or more;
X₁ represents —O—, —S—, —Si (R₃)(R₄)— or —C(R₅)(R₆)—;
X₂ represents —Si(R₃)(R₄)— or —C(R₅)(R₆)—; and
R₃, R₄, R₅ and R₆ each independently represents a hydrogen atom or a substituent, and
wherein two of R₃ to R₆ present on two atoms adjacent to each other may be coupled to form a double bond between the two adjacent atoms, and
wherein when there exist a plurality of X₁'s, X₂'s, R₁'s, R₂'s, R₃'s, R₄'s, R₅'s and R₆'s, the plurality of X₁'s, X₂'s, R₁'s, R₂'s, R₃'s, R₄'s, R₅'s and R₆'s each may be the same or different, and
wherein at least two of R₁ to R₆ may be coupled to form a ring or form a multimer of the compound represented by formula (I), provided that the compound represented by formula (I) has at least two hydrolytic groups as R₁, R₂, R₃, R₄, R₅ or R₆.

2. The film forming composition according to claim 1, which comprises at least one of two or more compounds represented by formula (I), a hydrolysate of the two or more compounds represented by formula (I) and a polycondensate of the two or more compounds represented by formula (I).

3. The film forming composition according to claim 1, which comprises the silicon surfactant in an amount of from 0.01 to 1 mass % based on a total amount of the film forming composition.

4. The film forming composition according to claim 3, which comprises the silicon surfactant in an amount of from 0.1 to 0.5 mass % based on a total amount of the film forming composition.

5. The film forming composition according to claim 1,
wherein the silicon surfactant contains an alkylene oxide and a dimethylsiloxane.

6. The film forming composition according to claim 1, which further comprises an organosilicon compound represented by formula (A) or a polymer obtained by utilizing the organosilicon compound represented by formula (A):
(Rₐ)_{q}—Si—(ORb)_{4-q} (A)
wherein Rₐ represents an alkyl group, an aryl group or a heterocyclic group;
R_{b} represents a hydrogen atom, an alkyl group, an aryl group or a silyl group; and
q represents an integer of from 0 to 4, and when q or 4-q is 2 or more, Ra's or Rb's may be the same or different.

7. The film forming composition according to claim 6,
wherein q is an integer of from 0 to 2, and R_{b} is an alkyl group.

8. A production process of a film, which comprises:
applying a composition according to claim 1 onto a substrate; and
heating the applied composition.

9. An insulating film formed from a composition according to claim 1.
